(19) United States
(12) Patent Application Publication
(10) Pub. No.: US 2014/0289608 A1
(43) Pub. Date: Sep. 25, 2014

(54) TERMINAL DEVICE, DISPLAY METHOD, AND SERVER DEVICE

(71) Applicant: YAHOO JAPAN CORPORATION, Tokyo (JP)

(72) Inventor: Shunsaku ASANO, Tokyo (JP)

(73) Assignee: YAHOO JAPAN CORPORATION, Tokyo (JP)

(21) Appl. No.: 14/180,952

(22) Filed: Feb. 14, 2014

(30) Foreign Application Priority Data
Mar. 22, 2013 (JP) 2013-060620

(51) Int. Cl. G06F 17/22

(52) U.S. Cl. CPC G06F 17/2247
USPC 715/234

(57) ABSTRACT

A terminal device includes an input receiving unit and a screen control unit. The input receiving unit receives input operation for inputting arbitrary information in an input field contained in an input screen. The screen control unit displays the input screen, as a confirmation screen, in which the input field is set to an uneditable state, when the information input in the input field through the input operation satisfies an input requirement of the input field.

### CROSS-REFERENCE TO RELATED APPLICATIONS

The present application claims priority to and incorporates by reference the entire contents of Japanese Patent Application No. 2013-060620 filed in Japan on Mar. 22, 2013.

### BACKGROUND OF THE INVENTION

1. Field of the Invention

The present invention relates to a terminal device, a display method, and a server device.

2. Description of the Related Art

As web pages distributed by web servers or the like to user terminals, web pages of input screens are known that allow users to input various types of information. For example, a web server may distribute a web page for inputting a name, an address, age, an e-mail address, or the like to register a user as a member.

The web server that distributes such a web page receives input information from a user terminal when input operation to input the input information in an input screen is performed and then operation to transmit the input information is subsequently performed, and verifies whether the received input information satisfies an input requirement. For example, the web server verifies whether information is input in a required item or whether only available types of characters (one-byte numbers, one-byte English characters, or the like) are input. If there is no problem with a verification result, the web server distributes a web page of a confirmation screen displaying the input information to the user terminal to cause the user to confirm whether the input information is accurate. If registration operation is performed on the confirmation screen, the web server performs various processes, such as member registration, by using the input information.

However, in the technology as described above, development costs of the web pages may increase. Specifically, in the technology, it is needed to prepare web pages of confirmation screens corresponding to respective input screens, so that man-hours to develop the web pages of the confirmation screens increase. In particular, if a service for distributing a large variety of input screens is to be provided, confirmation screens corresponding to the various input screens are needed, resulting in increased development costs.

### SUMMARY OF THE INVENTION

It is an object of the present invention to at least partially solve the problems in the conventional technology.

According to one aspect of an embodiment, a terminal device includes an input receiving unit configured to receive input operation for inputting arbitrary information in an input field contained in an input screen; and a screen control unit configured to display the input screen, as a confirmation screen, in which the input field is set to an uneditable state, when the information input in the input field through the input operation satisfies an input requirement of the input field.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an example of a web page display process according to an embodiment;

FIG. 2 is an explanatory diagram illustrating an example of the web page display process according to the embodiment;

FIG. 3 is a diagram illustrating a configuration example of a terminal device according to the embodiment;

FIG. 4 is a diagram illustrating a configuration example of a web server according to the embodiment;

FIG. 5 is a sequence diagram illustrating the flow of a process performed by a web system according to the embodiment;

FIG. 6 is a flowchart illustrating the flow of a display process performed by the terminal device according to the embodiment;

FIG. 7 is an explanatory diagram illustrating an example of the web page display process according to the embodiment;

FIG. 8 is an explanatory diagram illustrating an example of the web page display process according to the embodiment; and

FIG. 9 is an explanatory diagram illustrating an example of the web page display process according to the embodiment.

### DETAILED DESCRIPTION OF THE PREFERRED EMBODIMENTS

Exemplary embodiments (hereinafter, referred to as “embodiments”) of a terminal device, a display method, a display control program, and a server device will be explained in detail below with reference to accompanying drawings. The terminal device, the display method, the display control program, and the server device are not limited to the embodiments below. In the embodiments, the same components are denoted by the same reference numerals and symbols, and the same explanation will not be repeated.

1. Web Page Display Process

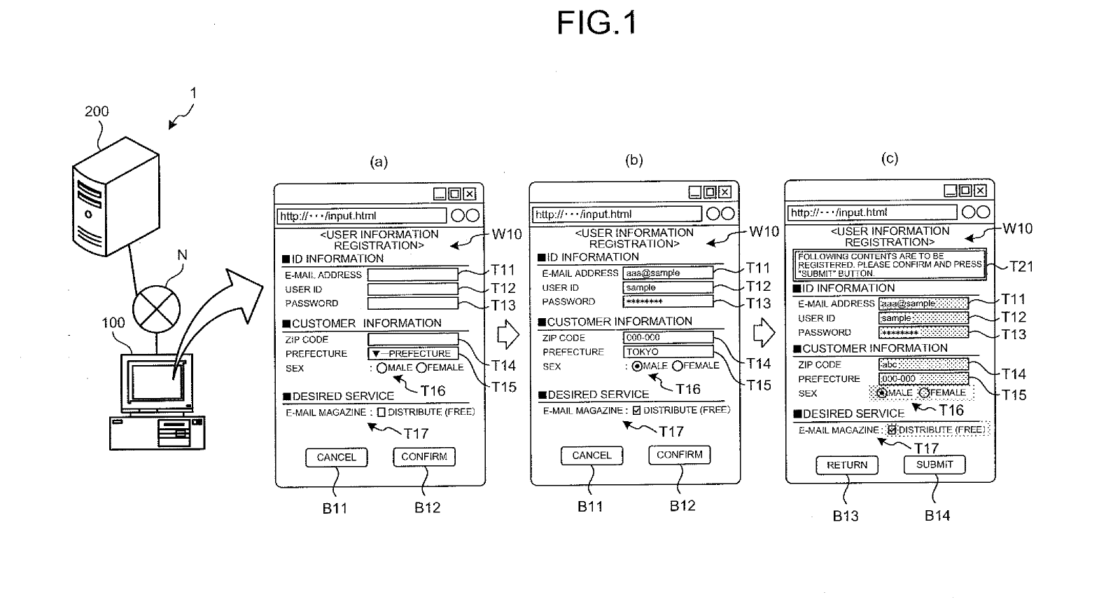

An example of a web page display process according to an embodiment will be explained below with reference to FIG. 1. FIG. 1 is an explanatory diagram illustrating an example of the web page display process according to the embodiment. In the example in FIG. 1, a web system 1 performs a process for displaying a web page.

As illustrated in FIG. 1, the web system 1 includes a terminal device 100 and a web server 200. The terminal device 100 and the web server 200 are connected to each other via a network N such that wired or wireless communication is enabled. The web system 1 illustrated in FIG. 1 may include multiple terminal devices 100 or multiple web servers 200.

The terminal device 100 is an information processing apparatus, such as a desktop personal computer (PC), a notebook PC, a tablet device, a mobile phone, or a personal digital assistant (PDA). The terminal device 100 is equipped with a web browser and displays various web pages distributed by the web server 200. It is assumed that the web browser installed on the terminal device 100 is compatible with Asynchronous Javascript (registered trademark) and XML (Ajax) using asynchronous communication.

The web server 200 is a server device that distributes various web pages to the terminal device 100. The web pages distributed by the web server 200 correspond to HyperText Markup Language (HTML) files written in, for example, HTML, JavaScript (registered trademark), or Cascading Style Sheets (CSS). The web server 200 provides various services, such as shopping sites or auction sites, and in some cases, requests a user to register as a member for the services to be provided. The web server 200 distributes a web page (that is, an input screen) for inputting user information needed to for member registration.

In the web system 1 according to the embodiment, a single web page functions both as an input screen and a confirmation screen that is a screen to cause a user to confirm input information input in the input screen. Therefore, the web system 1 according to the embodiment can reduce development costs of web pages. This will be explained below with an example illustrated in FIG. 1.

As illustrated in FIG. 1(a), the terminal device 100 displays a web page W10 acquired from the web server 200. The web page W10 is an input screen to cause a user to input various types of information, and contains input fields T11 to T17, a cancel button B11, a confirmation button B12, and the like. The input fields T11 to T14 are text boxes for inputting an “e-mail address”, a “user ID”, a “password”, and a “zip code”, respectively. The input field T15 is a pull-down field for selecting a “prefecture”. The input field T16 is a checkbox for selecting “sex”. The input field T17 is a checkbox for designating “e-mail magazine subscription/unsubscription”. The cancel button B11 is a button for cancelling input of information in the web page W10. The confirmation button B12 is a button for transmitting the input information input in the web page W10 to the web server 200.

Subsequently, the user inputs various types of information in the input fields T11 to T17 as illustrated in FIG. 1(b) and then presses the confirmation button 512. In this case, the terminal device 100 according to the embodiment transmits the pieces of the input information input in the input fields T11 to T17 to the web server 200 through asynchronous communication using Ajax or the like. In the example in FIG. 1(b), the terminal device 100 transmits the pieces of the input information, such as an e-mail address of “aaa@sample” and a user ID of “sample”, to the web server 200 through the asynchronous communication. When the asynchronous communication using Ajax is employed, the terminal device 100 transmits an XMLHttp request containing the pieces of the input information input in the input fields T11 to T17 to the web server 200. The terminal device 100 may implement the asynchronous communication as described above by, for example, Javascript or the like written in an HTML file of the web page W10.

Subsequently, when receiving the pieces of the input information from the terminal device 100, the web server 200 verifies whether the received pieces of the input information satisfy input requirements. Specifically, input requirements, such as an “available character type (one-byte numbers, one-byte English characters, two-byte numbers, two-byte English characters, hiragana, katakana, symbol, Chinese characters, or the like)”, a “minimum character count”, a “maximum character count”, or “whether it is a required item”, are determined in advance for the input fields T11 to T17 contained in the web page W10. The web server 200 verifies whether each of the pieces of the input information received from the terminal device 100 satisfies the input requirements, and transmits verification results to the terminal device 100. Incidentally, a verification process as described above may be referred to as a validation check or the like.

In the example in FIG. 1, the web server 200 transmits, to the terminal device 100, verification results indicating that all of the pieces of the input information satisfy the Input requirements. In this case, as illustrated in FIG. 1(c), the terminal device 100 dynamically (in a dynamic manner) rewrites a part of the currently-displayed web page W10 by using a technology called dynamic HTML to reflect the verification results received from the web server 200 in the web page W10.

Specifically, if all of the pieces of the input information satisfy the input requirements, the terminal device 100 sets the input fields T11 to T17 to an uneditable state and changes display colors of the input fields T11 to T17. More specifically, the terminal device 100 controls the input fields T11 to T17 such that the pieces of the input information are uneditable while the pieces of the input information are displayed in the input fields T11 to T17. Furthermore, the terminal device 100 displays, in a display space T21, a text to notify the user that the web page W10 is serving as the confirmation screen. Moreover, the terminal device 100 hides the cancel button Ell and the confirmation button B12 displayed in FIG. 1(b), and displays a return button B13 and a submit button E14. Various processes performed by the terminal device 100 as described above may be implemented by, for example, Javascript, CSS, or the like written in the HTML file of the web page W10.

As described above, when all of the pieces of the input information satisfy the input requirements, the terminal device 100 dynamically changes the input fields T11 to T17 of the web page W10 used as the input screen to the uneditable state in order to use the same web page W10 as the confirmation screen. In other words, the terminal device 100 switches the web page W10 from the input screen to the confirmation screen without screen transition or reload to occur. Therefore, the web system 1 according to the embodiment does not need a web page of the confirmation screen corresponding to the web page W10, so that development costs of the web page can be reduced. Furthermore, the terminal device 100 can notify the user of the uneditable state by changing the display colors of the input fields T11 to T17. Therefore, it is possible to notify the user that the web page W10 is serving as the confirmation screen. Namely, the web system 1 according to the embodiment can provide the user with the same operational feeling as achieved with a conventional user interface in which the input screen and the confirmation screen are formed by different web pages.

If the return button 513 is pressed in the state illustrated in FIG. 1(c), the web page W10 is returned to the state illustrated in FIG. 1(b), although this is not explained above. Specifically, the terminal device 100 sets the input fields T11 to T17 to an editable state and returns the display colors of the input fields T11 to T17 to original colors (the state of the input screen). Even in this case, the terminal device 100 switches the web page W10 from the confirmation screen to the input screen without screen transition or reload to occur.

Furthermore, if the submit button B14 is pressed in the state illustrated in FIG. 1(c), the terminal device 100 transmits the pieces of the input information input in the input fields T11 to T17 to the web server 200 by an HTTP request or the like. Accordingly, the terminal device 100 receives, from the web server 200, a web page or the like for completing registration, and displays the received web page for completing registration.

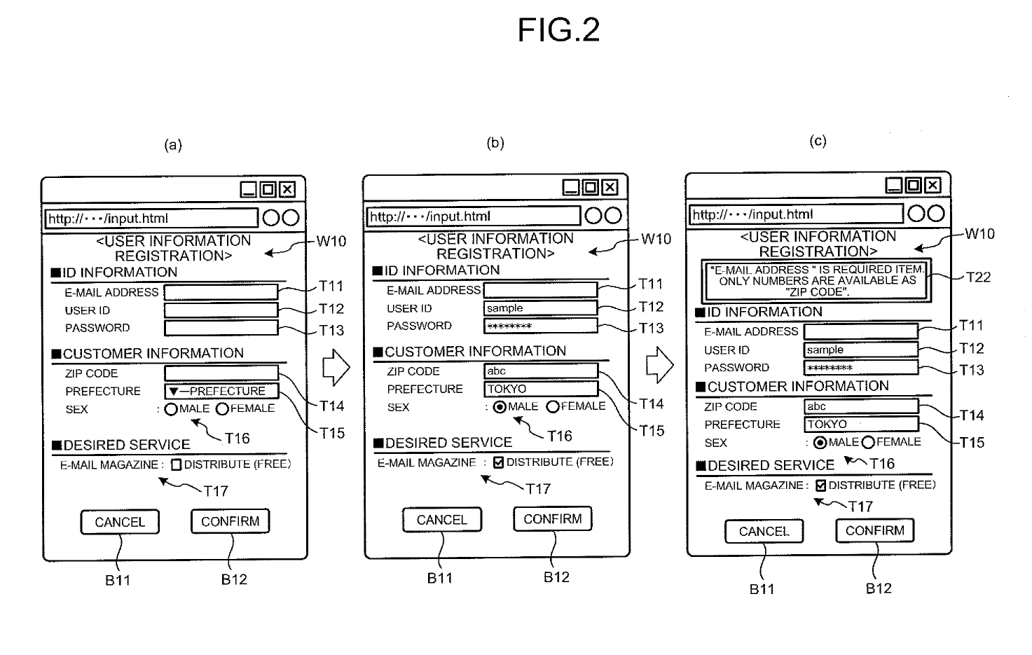

Moreover, while FIG. 1 illustrates an example in which all of the pieces of the input information satisfy the input requirements, if any of the pieces of the input information does not satisfy the input requirements, the terminal device 100 dynamically rewrites a part of the web page and displays an error message on the web page W10. This will be explained below with reference to FIG. 2.

FIG. 2(a) illustrates the same state as illustrated in FIG. 1(a). In this state, the user inputs various types of information as illustrated in FIG. 2(b) and then presses the confirmation button B12. In this example, the user does not input information in the input field T11 for an e-mail address and inputs information of “abc” in the input field T14 for a zip code. In this example, it is assumed that the input field T11 for an e-mail address is a required input item and only “one-byte numbers” and “one-byte hyphen” are available as input in the input field T14 for a zip code. In this case, the web server 200 detects that no information is input in the input field T11 and the information of “abc” input in the input field T14 is incorrect, and transmits the verification results obtained as above to the terminal device 100 through the asynchronous communication.

Then, when receiving the verification results indicating that the input requirements are not satisfied from the web server 200, the terminal device 100 dynamically rewrites a part of the currently-displayed web page W10 to display the verification results on the web page W10. Specifically, as illustrated in FIG. 2(c), the terminal device 100 displays an error message such as ““an e-mail address” is a required item” or ““only numbers are available as input in a “zip code””, in the display space T22. An error message display process performed by the terminal device 100 as described above is implemented by, for example, Javascript, CSS, or the like written in the HTML file of the web page W10. Incidentally, in the example in FIG. 2(c), in contrast to the example in FIG. 1(c), the terminal device 100 does not perform the process for setting the input fields T11 to T17 to the uneditable state, the process for changing the display colors of the input fields T11 to T17, and the process for displaying the return button B13 and the submit button B14

As described above, if there is a piece of the input information that does not satisfy the input requirements, the terminal device 100 dynamically rewrites the web page W10 to display the error message. In other words, the terminal device 100 switches the web page W10 from the input screen to an input screen containing the error message without screen transition. Therefore, in the web system 1 according to the embodiment, a web page for displaying the error message according to the web page W10 serving as the input screen is not needed, so that development costs of the web page can be reduced.

As described above, according to the web system 1 of the embodiment, a single web page functions as the input screen, the confirmation screen, and the input screen containing the error message. Therefore, development costs of the web pages can be reduced. In the following, the terminal device 100 and the web server 200 that perform the display process as described above will be explained.

2. Configuration of the Terminal Device

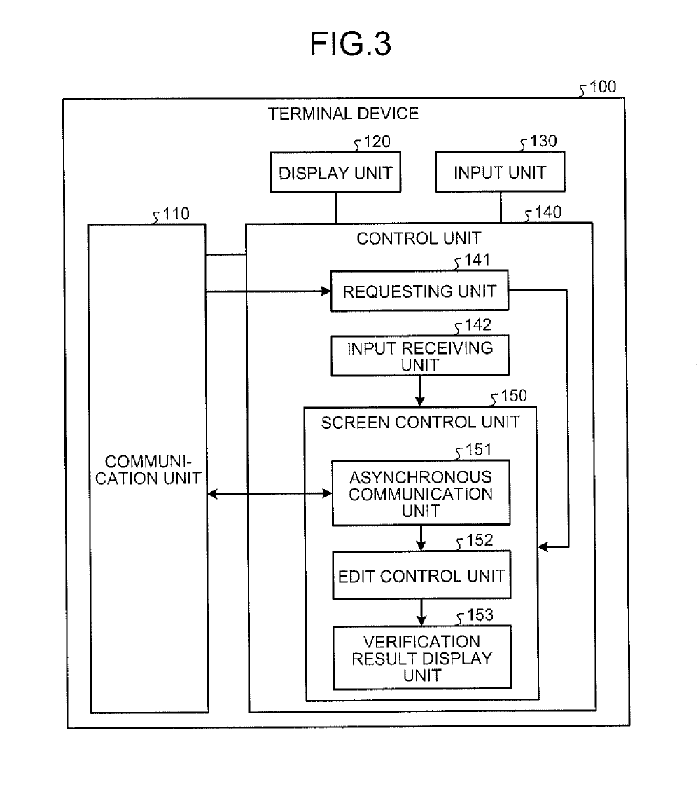

A configuration of the terminal device 100 according to the embodiment will be explained below with reference to FIG. 3. FIG. 3 is a diagram illustrating a configuration example of the terminal device 100 according to the embodiment. As illustrated in FIG. 3, the terminal device 100 includes a communication unit 110, a display unit 120, an input unit 130, and a control unit 140.

Communication Unit 110

The communication unit 110 is connected to the network N, and transmits and receives information to and from the web server 200 via the network N. The communication unit 110 is connected to the network N with or without wires.

Display Unit 120 and Input Unit 130

The display unit 120 is a display device that displays various types of information. For example, the display unit 120 is implemented by a liquid crystal display or the like. The input unit 130 is an input device that receives various types of operation from a user. For example, the input unit 130 is implemented by a keyboard, a mouse, or the like.

Control Unit 140

The control unit 140 is implemented by, for example, causing a central processing unit (CPU), a micro processing unit (MPU), or the like to execute an application program (an example of a display control program) called a web browser or the like that is stored in a storage device inside the terminal device 100 by using a random access memory (RAM) as a work area. Alternatively, the control unit 140 may be implemented by an integrated circuit, such as an application specific integrated circuit (ASIC) or a field programmable gate array (FPGA).

The control unit 140 includes, as illustrated in FIG. 3, a requesting unit 141, an input receiving unit 142, and a screen control unit 150, and implements and performs functions and operation of information processing as described below. Incidentally, the internal configuration of the control unit 140 is not limited to the configuration illustrated in FIG. 3, and other configurations may be employed as long as the information processing as described below is possible. Furthermore, a connection relation of the processing units of the control unit 140 is not limited to the connection relation illustrated in FIG. 3, and a different connection relation may be employed.

Requesting Unit 141

The requesting unit 141 transmits a web page acquisition request (HTTP request) to the web server 200 according to user operation using the input unit 130. The requesting unit 141 acquires a web page transmitted by the web server 200 in response to the acquisition request.

Input Receiving Unit 142

The input receiving unit 142 receives various types of operation on the web page displayed on the display unit 120. For example, the input receiving unit 142 receives input operation for inputting arbitrary information in the input fields contained in the input screen as illustrated in FIG. 1 or FIG. 2. Furthermore, the input receiving unit 142 receives a press operation for pressing the cancel button 311, the confirmation button B12, the return button B13, or the submit button B14 as illustrated in FIG. 1 or FIG. 2.

Screen Control Unit 150

The screen control unit 150 displays, on the display unit 120, the web page acquired by the requesting unit 141. Furthermore, the screen control unit 150 performs a process for transmitting input information input in the currently-displayed web page through asynchronous communication, or a process for dynamically rewriting the currently-displayed web page.

The screen control unit 150 as described above includes, as illustrated in FIG. 3, an asynchronous communication unit 151, an edit control unit 152, and a verification result display unit 153. The asynchronous communication unit 151, the edit control unit 152, and the verification result display unit 153 are implemented by executing an HTML file, in which JavaScript (registered trademark) or CSS is written, by using a RAM as a work area.

Asynchronous Communication Unit 151

The asynchronous communication unit 151 performs asynchronous communication using Ajax or the like with the web server 200. Specifically, the asynchronous communication unit 151 transmits input information input in the web page to the web server 200 through the asynchronous communication without causing screen transition or reload of the web page to occur, and receives a verification result of the input information from the web server 200 through the asynchronous communication. For example, when the asynchronous communication using Ajax is employed, the asynchronous communication unit 151 transmits an XMLHttp request containing the input information to the web server 200, and receives a verification result in response to the XMLHttp request.

Incidentally, if the user performs input completion operation, the asynchronous communication unit 151 according to the embodiment transmits the input information to the web server 200 through the asynchronous communication. For example, in the example in FIG. 1 or FIG. 2, when operation for pressing the confirmation button B12 in the web page W10 (in other words, transmission operation for transmitting pieces of the input information to the web server 200) is performed, the asynchronous communication unit 151 transmits the pieces of the input information input in the input fields T11 to T17 to the web server 200 through the asynchronous communication.

An example of information transmitted by the asynchronous communication unit 151 will be explained below. The asynchronous communication unit 151 transmits, to the web server 200, a combination of a “key” that is an input-field identifier for identifying each of the input fields contained in the web page and a “value” that is a piece of input information input in the corresponding input field. For example, it is assumed that keys of “mail”, “userid”, and “passwd” are assigned to the input fields T11 to T13 illustrated in FIG. 1 and FIG. 2, respectively. In this case, if the confirmation button B12 is pressed in the state as illustrated in FIG. 1(b), the asynchronous communication unit 151 transmits a combination of the key of “mail” and a value of “aaa@sample”, a combination of the key of “userid” and a value of “sample”, and a combination of the key of “passwd” and a value of “******** (for example, an actually-input password “12345678” or the like)” to the web server 200. Furthermore, the asynchronous communication unit 151 also transmits combinations of keys and values of the other input fields T14 to T17 to the web server 200, although explanation thereof will be omitted.

Subsequently, the asynchronous communication unit 151 receives combinations of the keys and verification results from the web server 200. For example, if the keys and the values are transmitted as in the above example, the asynchronous communication unit 151 receives information indicating satisfaction of an input requirement, as a verification result corresponding to the key of “mail”. Similarly, the asynchronous communication unit 151 receives verification results for the other items, such as the key of “userid” and the key of “passwd”.

Furthermore, as illustrated in FIG. 2(b) for example, if information is not input in the input field T11 for an e-mail address, the asynchronous communication unit 151 transmits a combination of the key of “mail” and a value of null (no information) to the web server 200, or does not transmit a combination of the key of “mail” and the value to the web server 200. In this case, for example, the asynchronous communication unit 151 receives, as a verification result corresponding to the key of “mail”, error information indicating that information is not input in an input required item from the web server 200.

Moreover, the asynchronous communication unit 151 may receive only the verification results from the web server 200 without receiving the keys. In this case, the asynchronous communication unit 151 receives a string of verification results that are delimited by a predetermined delimiter (for example, a comma “,”) in a predetermined order of the input fields. For example, it is assumed that the verification results transmitted by the web server 200 are arranged in order of the keys of “mail”, “userid”, and “passwd”. In this case, the asynchronous communication unit 151 receives, as the verification results, “(information indicating violation of a required item), (information indicating satisfaction of an input requirement), (information indicating satisfaction of an input requirement)” or the like from the web server 200. In this example, the first string of “(information indicating violation of a required item)” is the verification result corresponding to the key of “mail”, the second string of “(information indicating satisfaction of an input requirement)” is the verification result corresponding to the key of “userid”, and the third string of “(information indicating satisfaction of an input requirement)” is the verification result corresponding to the key of “passwd”.

Edit Control Unit 152

The edit control unit 152 dynamically controls the editability of each of the input fields contained in the web page by using a technology called dynamic HTML or the like without causing transition or reload of the web page displayed on the display unit 120 to occur. Specifically, the edit control unit 152 determines whether all of the pieces of the input information input in the web page satisfy the input requirements, based on the verification results that the asynchronous communication unit 151 has received from the web server 200. If all of the pieces of the input information satisfy the input requirements, the edit control unit 152 sets each of the input fields of the web page displayed on the display unit 120 to the uneditable state. At this time, the edit control unit 152 displays the input fields in the uneditable state such that the uneditable state can be discriminated. For example, as illustrated in the example in FIG. 1, the edit control unit 152 changes the display colors of the input fields to a certain color (gray or the like) that normally reminds a user that input is not allowed.

Furthermore, when operation for returning the screen state is performed in the screen in which each of the input fields is set to the uneditable state, the edit control unit 152 sets each of the input fields to the editable state. For example, if the return button B13 is pressed in the state illustrated in FIG. 1(c), the edit control unit 152 returns the input fields T11 to T17 to the editable state and returns the display colors of the input fields T11 to T17 to colors that have been displayed when the information is input.

Verification Result Display Unit 153

The verification result display unit 153 dynamically rewrites a part of the web page being displayed on the display unit 120, based on the verification results that the asynchronous communication unit 151 has received from the web server 200. Specifically, if any of the pieces of the input information does not satisfy the input requirements, the verification result display unit 153 generates an error message from the verification results and displays the generated error message on the web page. In this case, the verification result display unit 153 displays the error message on the web page without causing transition or reload of the web page displayed on the display unit 120 to occur.

Furthermore, if all of the pieces of the input information satisfy the input requirements, as illustrated in the example in FIG. 1(c) for example, the verification result display unit 153 displays a text indicating that the web page is serving as the confirmation screen, or switches between various buttons to be displayed.

A verification result display process performed by the verification result display unit 153 will be described below. For example, as in the example described above, it is assumed that the asynchronous communication unit 151 has received “(information indicating violation of a required item), (information indicating satisfaction of an input requirement), and (information indicating satisfaction of an input requirement)” as the verification results corresponding to the keys of “mail”, “userid”, and “passwd”. In this case, for example, the verification result display unit 153 generates an error message such as ““an e-mail address” is a required item” as illustrated in FIG. 2(c), based on the verification result of “(information indicating violation of a required item)” corresponding to the key of “mail”. Then, the verification result display unit 153 dynamically rewrites the web page W10 displayed on the display unit 120 to thereby display the generated error message in the display space T22 of the web page W10.

Furthermore, for example, it is assumed that the asynchronous communication unit 151 receives the information indicating satisfaction of the input requirements as the verification results corresponding to all of the keys. In this case, the verification result display unit 153 dynamically rewrites the web page W10 to display, in the display space T21 of the web page W10, a text such as “registration is performed with the following contents . . . . ” as illustrated in the example in FIG. 1(c). Moreover, the verification result display unit 153 hides the cancel button B11 and the confirmation button B12 and displays the return button B13 and the submit button B14 as illustrated in the example in FIG. 1(c).

3. Configuration of the Web Server

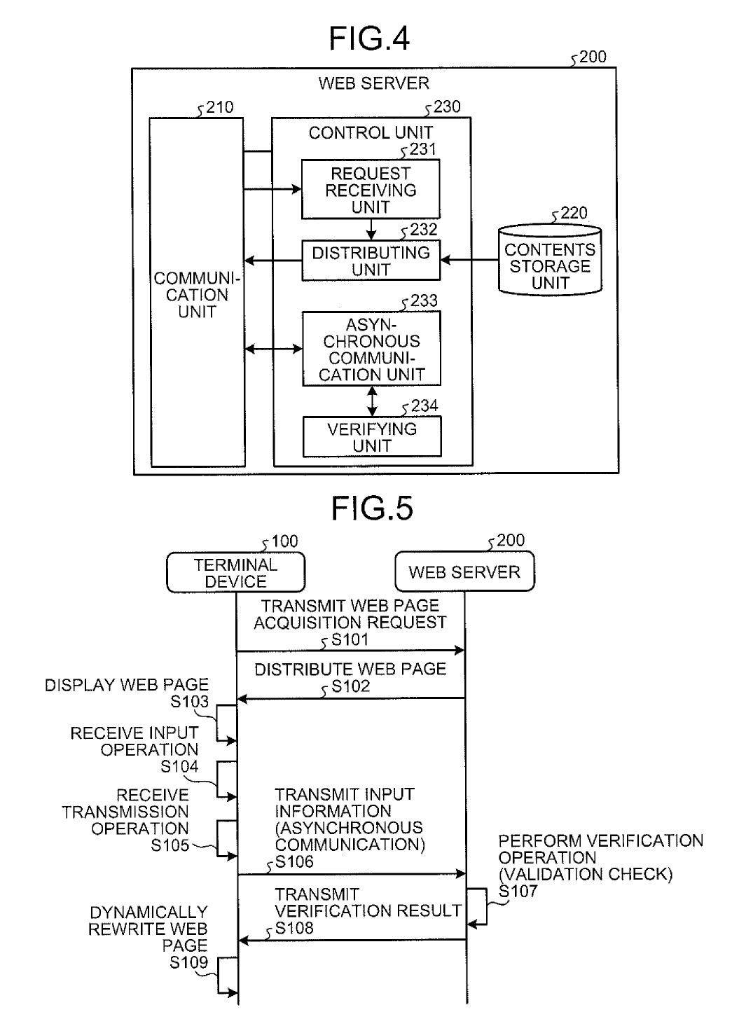

A configuration of the web server 200 according to the embodiment will be explained below with reference to FIG. 4. FIG. 4 is a diagram illustrating a configuration example of the web server 200 according to the embodiment. As illustrated in FIG. 1, the web server 200 includes a communication unit 210, a contents storage unit 220, and a control unit 230.

Communication Unit 210

The communication unit 210 is connected to the network N, and transmits and receives information to and from the terminal device 100 via the network N. The communication unit 210 is connected to the network N with or without wires.

Contents Storage Unit 220

The contents storage unit 220 is implemented by a semiconductor memory device, such as a RAM or a flash memory, or by a storage device, such as a hard disk or an optical disk. The contents storage unit 220 stores therein web pages or components of the web pages, which are examples of contents. For example, the contents storage unit 220 stores therein an HTML file of a web page, image data included in a web page, or the like.

Control Unit 230

The control unit 230 is implemented by, for example, causing a CPU, an MPU, or the like to execute various programs stored in the storage device inside the terminal device 100 by using a RAM as a work area. Alternatively, the control unit 230 may be implemented by an integrated circuit, such as an ASIC or an FPGA.

The control unit 230 includes, as illustrated in FIG. 4, a request receiving unit 231, a distributing unit 232, an asynchronous communication unit 233, and a verifying unit 234, and implements and performs functions and operation of information processing as described below. Incidentally, the internal configuration of the control unit 230 is not limited to the configuration illustrated in FIG. 4, and other configurations may be employed as long as the information processing as described below is possible. Furthermore, a connection relation of the processing units of the control unit 230 is not limited to the connection relation illustrated in FIG. 4, and a different connection relation may be employed.

Request Receiving Unit 231

The request receiving unit 231 receives the web page acquisition request (HTTP request or the like) transmitted by the requesting unit 141 of the terminal device 100. The request receiving unit 231 outputs the acquisition request received from the terminal device 100 to the distributing unit 232.

Distributing Unit 232

The distributing unit 232 acquires, from the contents storage unit 220, a web page requested by the acquisition request received by the request receiving unit 231, and distributes the acquired web page to the terminal device 100. For example, the distributing unit 232 distributes a web page, in which a display control program is embedded to implement the processes performed by the screen control unit 150 of the terminal device 100. The display control program corresponds to, for example, a source code of Javascript, CSS, or the like written in the web page.

Asynchronous Communication Unit 233

The asynchronous communication unit 233 performs asynchronous communication with the terminal device 100. Specifically, the asynchronous communication unit 233 receives pieces of input information input in the web page from the asynchronous communication unit 151 of the terminal device 100, and outputs the received pieces of input information to the verifying unit 234. Then, the asynchronous communication unit 233 transmits a verification result obtained by the verifying unit 234 to the terminal device 100 through the asynchronous communication.

Verifying Unit 234

The verifying unit 234 verifies whether each of the pieces of the input information received by the asynchronous communication unit 233 satisfies the input requirements. Specifically, the input requirements for each of the input fields contained in the web page distributed by the distributing unit 232 are determined in advance. For example, “required item” and “only one-byte English characters, one-byte numbers, and predetermined symbols (for example, “@” or “-”) are available” are determined as the requirements for the key of “mail”. The verifying unit 234 determines whether a value (the input information) satisfies the input requirements corresponding to a key for each of the combinations of the keys and the values transmitted by the terminal device 100. Then, the verifying unit 234 generates a verification result, such as “the input requirement is satisfied”, “there is a violation of a required item”, or “there is a violation of a designated character (an unavailable character type is input)”, and outputs the generated verification result to the asynchronous communication unit 233. Therefore, the asynchronous communication unit 233 transmits the verification result to the terminal device 100.

4. Flow of a Process Performed by the Web System

The flow of a process performed by the web system 1 according to the embodiment will be explained below with reference to FIG. 5. FIG. 5 is a sequence diagram illustrating the flow of the process performed by the web system 1 according to the embodiment.

As illustrated in FIG. 5, the requesting unit 141 of the terminal device 100 transmits a web page acquisition request to the web server 200 according to user operation (Step S101). Accordingly, the request receiving unit 231 of the web server 200 receives the web page acquisition request from the terminal device 100.

Subsequently, the distributing unit 232 of the web server 200 distributes, to the terminal device 100, a web page requested by the acquisition request received from the terminal device 100 (Step S102). In this example, the distributing unit 232 distributes a web page containing the input fields for inputting various types of information as illustrated in FIG. 1 or FIG. 2.

The screen control unit 150 of the terminal device 100 displays the web page received from the web server 200 on the display unit 120 (Step S103). The input receiving unit 142 of the terminal device 100 receives input operation for inputting pieces of arbitrary information in the web page displayed on the display unit 120 (Step S104), and thereafter receives transmission operation for transmitting the pieces of the input information to the web server 200 (for example, operation for pressing the confirmation button B12) (Step S105). In this case, the asynchronous communication unit 151 of the terminal device 100 transmits the pieces of the input information input in the web page to the web server 200 through the asynchronous communication (Step S106).

Subsequently, the verifying unit 234 of the web server 200 verifies whether each of the pieces of the input information received from the terminal device 100 satisfies the input requirements (Step S107). The asynchronous communication unit 233 of the web server 200 transmits a verification result of each of the pieces of the input information obtained by the verifying unit 234 to the terminal device 100 through the asynchronous communication (Step S108).

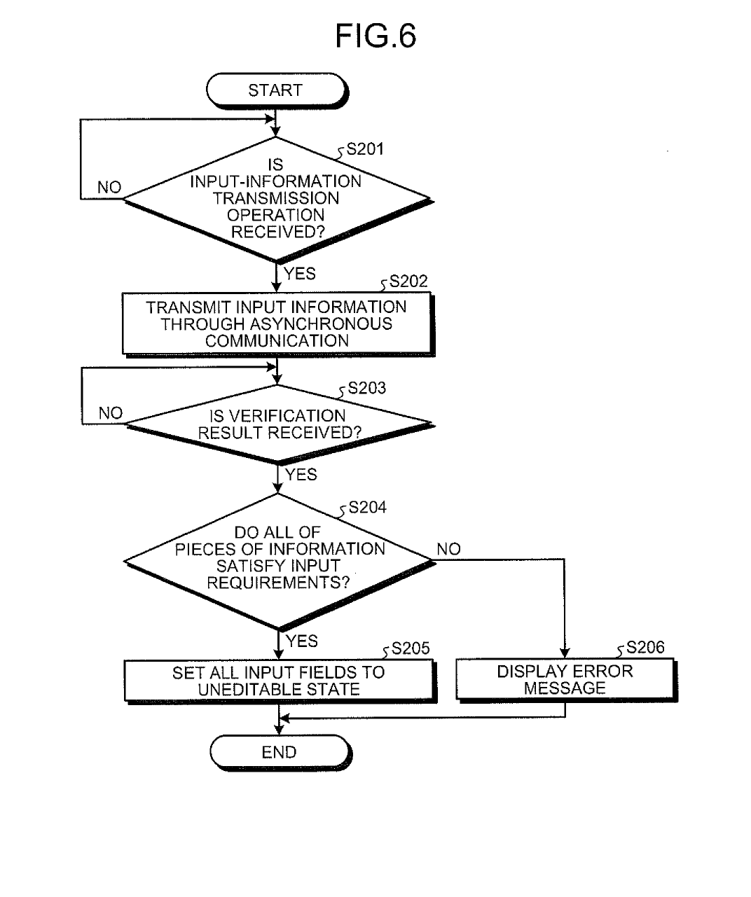

The screen control unit 150 of the terminal device 100 dynamically rewrites the web page displayed on the display unit 120 based on the verification results received from the web server 200 (Step S109). The process at Step S109 will be explained in detail below with reference to FIG. 6.

5. Flow of a Display Process Performed by the Terminal Device

The flow of a display process performed by the terminal device 100 according to the embodiment will be explained below with reference to FIG. 6. FIG. 6 is a flowchart illustrating the flow of the display process performed by the terminal device 100 according to the embodiment. In FIG. 6, it is assumed that the web page containing the input fields is displayed on the display unit 120.

As illustrated in FIG. 6, the input receiving unit 142 of the terminal device 100 determines whether it has received the transmission operation for transmitting the pieces of the input information input in the web page (Step S201). If the input receiving unit 142 has received the transmission operation (YES at Step S201), the asynchronous communication unit 151 transmits the pieces of the input information input in the web page to the web server 200 through the asynchronous communication (Step S202).

Subsequently, the asynchronous communication unit 151 determines whether it has received the verification results of the pieces of the input information from the web server 200 (Step S203). If the asynchronous communication unit 151 has received the verification results (YES at Step S203), the edit control unit 152 determines whether all of the pieces of the input information satisfy the input requirements based on the verification results (Step S204). If all of the pieces of the input information satisfy the input requirements (YES at Step S204), the edit control unit 152 sets each of the input fields in the web page displayed on the display unit 120 to the uneditable state (Step S205).

Similarly, the verification result display unit 153 determines whether all of the pieces of the input information satisfy the input requirements based on the verification results received from the web server 200 (Step S204). If any of the pieces of the input information does not satisfy the input requirements (NO at Step S204), the verification result display unit 153 generates an error message from the verification results and displays the generated error message on the web page (Step S206).

Incidentally, the user can correct the input information that has already been input in the input screen in which the error message is being displayed. In this case, the terminal device 100 and the web server 200 repeat the process from Step S104 to S109 illustrated in FIG. 5 and the process illustrated in FIG. 6.

Furthermore, in the example illustrated in FIG. 6, the process for determining whether all of the pieces of the input information satisfy the input requirements may be performed by the screen control unit 150 or may be performed by a predetermined determining unit, although not illustrated in FIG. 3.

6. Modifications

The web system 1 according to the embodiment as described above may be embodied in various forms other than the above embodiment. Therefore, other embodiments of the web system 1 will be explained below.

6-1. Transmission Timing of the Input Information (1)

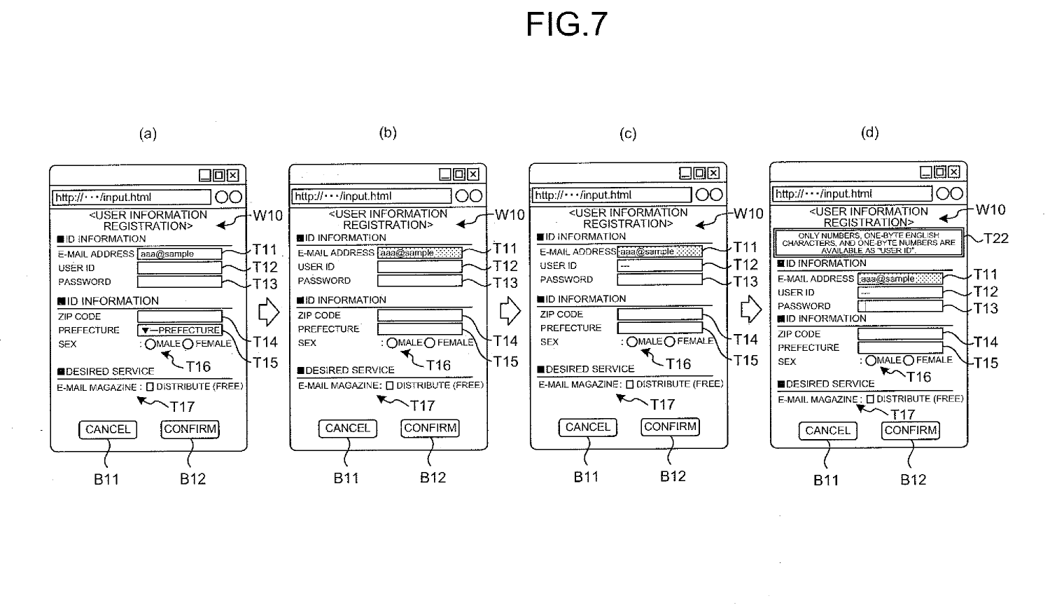

In the embodiment, an example is explained in which the terminal device 100 transmits the pieces of the input information to the web server 200 upon receiving the input completion operation (for example, when the confirmation button B12 is pressed); however, it is not limited thereto. The terminal device 100 may automatically transmit the pieces of the input information to the web server 200 at a predetermined timing without receiving the input completion operation. For example, when input of information in a first input field is completed and then input of information in a second input field is started, the terminal device 100 may transmit the input information input in the first input field to the web server 200. This will be explained below with reference to FIG. 7.

In an example in FIG. 7(a), “aaa@sample” is input in the input field T11 for an e-mail address. Subsequently, the user moves a cursor to the input field T12 to input a user ID as illustrated in FIG. 7(b). In this case, the asynchronous communication unit 151 of the terminal device 100 detects that an input-target (active) input field is changed from the input field T11 to the input field 212, and transmits the input information of “aaa@sample” that has just been input in the input field T11 to the web server 200 through the asynchronous communication.

Then, the asynchronous communication unit 233 of the web server 200 transmits, to the terminal device 100, a verification result for the input information of “aaa@sample” received from the terminal device 100. In this example, the asynchronous communication unit 233 transmits a verification result indicating that the input information satisfies the input requirements. In this case, as illustrated in FIG. 7(b), the edit control unit 152 sets the input field T11 to the uneditable state and changes the display color of the input field T11.

Subsequently, as illustrated in FIG. 7(c), the user inputs information such as “---” in the input field T12 for a user ID and moves the cursor to the input field T13. The asynchronous communication unit 151 transmits the input information of “---” input in the input field T12 to the web server 200 through the asynchronous communication, and receives a verification result of “there is a violation of a designated character (an unavailable character type is input)”. In this case, as illustrated in FIG. 7(d), the verification result display unit 153 displays an error message such as “only numbers, one-byte English characters, and one-byte numbers are available as input in a “user ID””, in the display space T22. Incidentally, in the example illustrated in FIG. 7(d), the edit control unit 152 does not perform the process for setting the input field 712 to the uneditable state or the process for changing the display color of the input field T12.

Subsequently, although it is not illustrated in the drawings, if pieces of information are input in all of the input fields T11 to T17 and all of the pieces of the input information satisfy the input requirements, the verification result display unit 153 displays a text indicating the confirmation screen in the display space T21 or displays the return button B13 and the submit button B14 in the same manner as the example illustrated in FIG. 1(c).

As described above, in contrast to the embodiment illustrated in FIG. 1 or FIG. 2, the terminal device 103 may dynamically set the input field to the uneditable state every time it receives information indicating that the input requirements are satisfied, and may dynamically display the error message every time it receives the information indicating that the input requirements are not satisfied, regardless of whether all of the pieces of the input information satisfy the input requirements. Therefore, the terminal device 100 can immediately notify the user whether the input requirements are satisfied, so that the usability can be enhanced.

While FIG. 7 illustrates an example in which the input information is transmitted when the cursor is moved to a different input field, the asynchronous communication unit 151 may transmit the input information in the input field to the web server 200 when the cursor moves out of the input field.

Furthermore, in the example in FIG. 7, the terminal device 100 may set the input field to the editable state when predetermined operation (for example, double-click operation on the input field) is performed on the input field that is in the uneditable state. With this configuration, the user can modify the input information that satisfies the input requirements.

6-2. Transmission Timing of the Input Information (2)

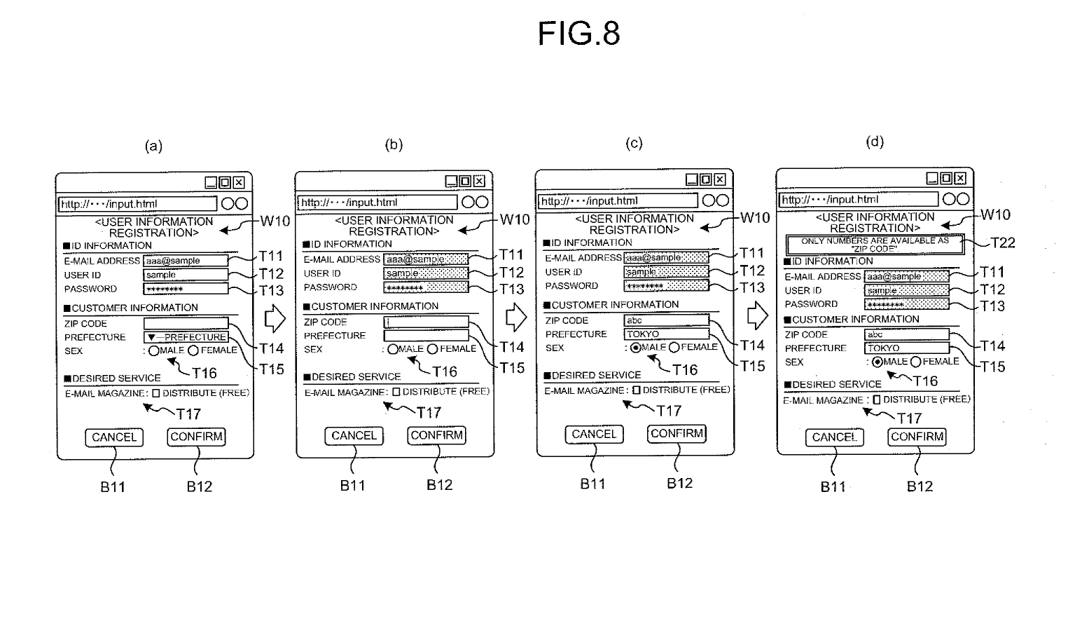

While FIG. 7 illustrates an example in which the terminal device 100 transmits the input information for each of the input fields, the terminal device 100 may collectively transmit, to the web server 200, pieces of the input information input in input fields belonging to the same group, for each of groups of the input fields. This will be explained below with reference to FIG. 8.

In the example in FIG. 8, the input fields T11 to T17 in the web page W10 are divided into three groups of “ID information”, “customer information”, and “desired service” such that the input fields T11 to T13 belong to the group of “ID information”, the input fields T14 to T16 belong to the group of “customer information”, and the input field T17 belongs to the group of “desired service”. In this state, as illustrated in FIG. 8(a), pieces of information are input in the input fields T11 to T13 and thereafter the cursor is moved to the input field T12 for a zip code. In this case, the asynchronous communication unit 151 detects that an input-target (active) group has switched from the group of “ID information” to the group of “customer information”, and transmits the pieces of the input information input in the input fields T11 to T13 belonging to the group of “ID information” to the web server 200 through the asynchronous communication.

The asynchronous communication unit 233 of the web server 200 transmits, to the terminal device 100, verification results of the respective pieces of the input information received from the terminal device 100. In this example, the asynchronous communication unit 233 transmits the verification results indicating that all of the pieces of the input information satisfy the input requirements. In this case, because all of the input fields T11 to T13 belonging to the group of “ID information” satisfy the input requirements, the edit control unit 152 sets the input fields T11 to T13 to the uneditable state and changes the display colors of the input fields T11 to T13 as illustrated in FIG. 8(b).

Subsequently, as illustrated in FIG. 8(c), the user inputs information of “abc” in the input field T14 for a zip code, and inputs pieces of information in the input fields T15 and T16 as illustrated in the figure. The asynchronous communication unit 151 transmits the pieces of the input information input in the input fields T14 to T16 to the web server 200 through the asynchronous communication, and receives “there is a violation of a designated character (an unavailable character type is input)” as the verification result corresponding to the input field T14 for a zip code. In this case, as illustrated in FIG. 8(d), the verification result display unit 153 displays an error message, such as “only numbers are available as input in a “zip code””, in the display space T22. In this case, because the group of “customer information” contains the input field T14 that does not satisfy the input requirement, the edit control unit 152 does not perform the process for setting the input fields T14 to T16 belonging to the group of “customer information” to the uneditable state and the process for changing the display colors of the input fields T14 to T16.

As described above, the terminal device 100 controls the editability of each of the groups of the input fields, so that the usability can be enhanced. For example, a web page may contain multiple related input fields, such as a zip code and a prefecture. In this case, the user may modify already-input related information while inputting information in a certain input field. In contrast, after the information is input in all of the related input fields, the user is less likely to modify the information input in the input fields. In the example in FIG. 8, the terminal device 100 controls the editability after the information is input in all of the related input fields. Therefore, it becomes possible to immediately notify the user whether a group of the related input fields satisfies the input requirements, so that the usability can be enhanced.

Incidentally, in the example in FIG. 8, when receiving predetermined operation on the group of the input fields in the uneditable state (for example, double-click operation on an input field), the terminal device 100 may set all of the input fields belonging to the group to the editable state. With this configuration, a user can modify the input information that satisfies the input requirements.

6-3. Editability Control

In the embodiments as described above, an example is explained that the edit control unit 152 sets all of the input fields to the uneditable state when all of the pieces of the input information satisfy the input requirements. However, the edit control unit 152 may set an input field to the uneditable state if the input field satisfies the input requirements based on the verification result received from the web server 200, and may set an input field to the editable state if the input field does not satisfy the input requirements.

6-4. Reset Process

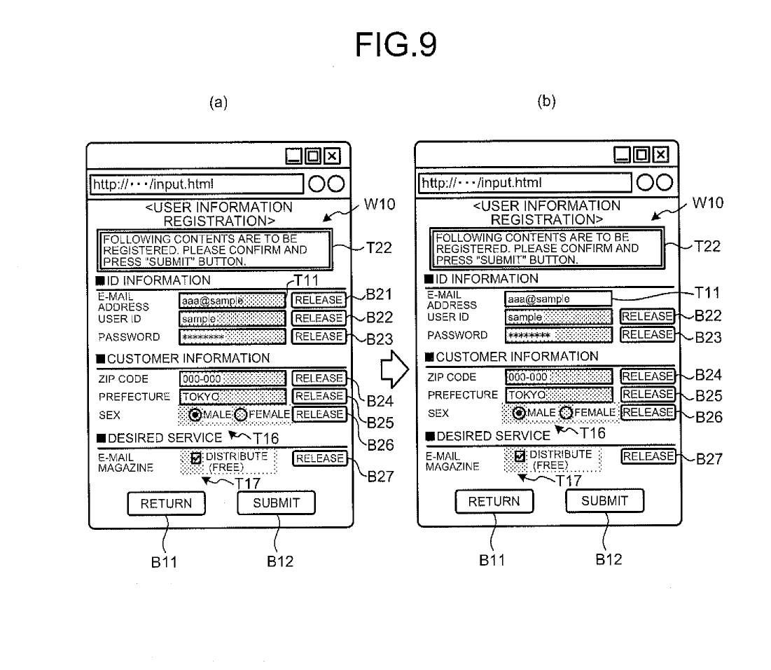

In the embodiments as described above, the edit control unit 152 of the terminal device 100 may display a button for returning to the editable state for each of the input fields when each of the input fields is set to an uneditable state. This will be explained below with reference to FIG. 9.

As described above, if all of the pieces of the input information input in the web page W10 satisfy the input requirements, the edit control unit 152 sets the pieces of the input information to the editable state. In this case, as illustrated in FIG. 9(a), the edit control unit 152 displays reset buttons B21 to B27 for returning to the editable state for each of the input fields. In the example in FIG. 9(a), the reset button B21 is a button for returning the input field T11 to the editable state. Similarly, the other reset buttons B22 to B27 are buttons for returning the input fields T12 to T17 to the editable state. For example, if the reset button B21 is pressed, the edit control unit 152 sets the input field T11 to the editable state and hides the reset button B21 as illustrated in FIG. 9(b).

As described above, the terminal device 100 displays the reset button for enabling edit to allow a user to freely modify the already-input information. Therefore, the usability can be enhanced.

Furthermore, in the examples illustrated in FIG. 7 and FIG. 8, the edit control unit 152 may display the reset button to set the input field to an editable state every time the input field is set to the uneditable state.

6-5. Subject of the Verification Process

In the embodiments as described above, an example is explained that the verifying unit 234 of the web server 200 performs the verification process (validation check) on the input information. However, the verification process may be performed by the terminal device 100. If the terminal device 100 performs the verification process, the input information and the verification result are not transmitted and received between the terminal device 100 and the web server 200, so that the traffic of the network N can be reduced. Incidentally, if the terminal device 100 performs the verification process, the terminal device 100 may not include the asynchronous communication unit 151. Furthermore, the terminal device 100 may implement the verification process by, for example, Javascript or the like written in the HTML file of the web page.

6-6. Display Colors of the Input Fields

In the embodiments as described above, an example is explained that the edit control unit 152 changes the display colors of the input fields that satisfy the input requirements. However, the edit control unit 152 need not always change the display colors of the input fields.

6-7. Asynchronous Communication

In the embodiments as described above, an example is explained that the asynchronous communication unit 151 transmits the input information to the web server 200 through the asynchronous communication. However, the terminal device 100 may transmit the input information to the web server 200 by an HTTP request. For example, if the confirmation button B12 is pressed in the example in FIG. 1(b), the terminal device 100 transmits the pieces of the input information in the input fields T11 to T17 to the web server 200 by an HTTP request. In this case, the web server 200 transmits the web page W10, in which the verification results of the respective pieces of the input information are reflected, to the terminal device 100. Accordingly, the terminal device 100 transmits the web page in the state as illustrated in FIG. 1(c). As described above, even when the web server 200 performs the process for dynamically rewriting the web page W10, the web page W10 can be used both as the input screen and the confirmation screen. Therefore, development costs of the web page can be reduced.

6-8. Others

Of the processes described in the embodiments, all or part of a process described as being performed automatically may also be performed manually. Alternatively, all or part of a process described as being performed manually may also be performed automatically by known methods. In addition, the processing procedures, specific names, and information including various types of data and parameters illustrated in the above-described document and drawings may arbitrarily be changed unless otherwise specified.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses can be functionally or physically distributed or integrated in arbitrary units according to various loads or use conditions.

For example, the web page W10 illustrated in FIG. 1, FIG. 2, and FIG. 7 to FIG. 9 is one example, and the web page is not limited thereto. For example, the web system 1 described above may be employed when a web page of a search screen for inputting multiple search keywords is distributed, in addition to the web page for member registration.

7. Advantageous Effects

As described above, the terminal device 100 according to the embodiments includes the input receiving unit 142 and the screen control unit 150. The input receiving unit 142 receives input operation for inputting arbitrary information in the input field contained in the input screen. When the information input in the input field through the input operation satisfies the input requirement of the input field, the screen control unit 150 displays, as the confirmation screen, an input screen in which the input fields are set to the uneditable state.

Therefore, the terminal device 100 according to the embodiments uses a single web page both as the input screen and the confirmation screen, so that development costs of the web page can be reduced.

Furthermore, in the terminal device 100 according to the embodiments, the screen control unit 150 includes the asynchronous communication unit 151 and the edit control unit 152. The asynchronous communication unit 151 transmits the input information to the web server 200 (an example of the server device) that provides the input screen through the asynchronous communication, and receives the verification result indicating whether the input information satisfies the input requirement from the web server 200 through the asynchronous communication. Furthermore, When the verification result received by the asynchronous communication unit 151 indicates that the input requirement is satisfied, the edit control unit 152 sets the input field to the uneditable state.

Therefore, the terminal device 100 according to the embodiments causes the server side (the web server 200), instead of the terminal side (the terminal device 100), to perform the verification process, so that the verification process can be performed with high reliability. For example, the verification process performed by the terminal device 100 is implemented by Javascript or the like written in the HTML file of the web page. However, Javascript or the like written in the HTML file may be invalidated by changing settings of a web browser or by falsification of the HTML file. Therefore, the verification process performed by the terminal device 100 is not always highly reliable. In contrast, the verification performed by the web server 200 according to the embodiments is not invalidated by user operation. Therefore, it becomes possible to reliably verify the pieces of the input information.

Moreover, in the terminal device 100 according to the embodiments, the screen control unit 150 includes the verification result display unit 153. The verification result display unit 153 displays the verification result on the input screen when the verification result received by the asynchronous communication unit 151 indicates that the input requirement is not satisfied.

Therefore, the terminal device 100 according to the embodiments can use a single web page both as the input screen and the input screen for displaying the error message. Therefore, development costs of the web pages can be reduced.

Furthermore, in the terminal device 100 according to the embodiments, the input receiving unit 142 receives operation for returning the screen state in the input screen in which the input fields are set to the uneditable state. Moreover, when the input receiving unit 142 receives the operation for returning the screen state, the edit control unit 152 sets the input fields to the editable state.

Therefore, the terminal device 100 according to the embodiments can reduce development costs of the web pages. For example, in general, when the returning operation is performed in the confirmation screen that simply displays the input information, the terminal device notifies the web server that the returning operation has been performed, and the web server generates a web page (input screen) containing the input information based on information contained in the confirmation screen and distributes the generated web page to the terminal device. In this method, it is needed to develop a web application that enables screen transition from the confirmation screen to the input screen, resulting in increased development costs. In contrast, when the return button B13 is pressed in the example illustrated in FIG. 1(c), the terminal device 100 according to the embodiments can switch from the confirmation screen (FIG. 1(c)) to the input screen (FIG. 1(b)) by only controlling the editability of the input fields, without notifying the web server 200 of the information. Therefore, if the terminal device 100 according to the embodiments is employed, it is not needed to develop a web application as described in the above example, so that development costs of the web pages can be reduced.

Moreover, in the terminal device 100 according to the embodiments, the input receiving unit 142 receives input operation on multiple input fields contained in the input screen. Furthermore, the asynchronous communication unit 151 transmits the input information to the web server 200 every time the information is input in any of the input fields, and receives a verification result of the input information from the web server 200. Moreover, the edit control unit 152 controls the editability of each of the input fields contained in the input screen based on the verification result received by the asynchronous communication unit 151.

Therefore, the terminal device 100 according to the embodiments can immediately notify the user whether the input information input by the user satisfies the input requirements, so that the usability can be enhanced.

Furthermore, in the terminal device 100 according to the embodiments, the edit control unit 152 displays the input fields in the uneditable state such that the uneditable state can be discriminated.

Therefore, the terminal device 100 according to the embodiments can notify the user of the uneditable state, and therefore can notify the user that the web page W10 is serving as the confirmation screen.

Moreover, in the terminal device 100 according to the embodiments, the input receiving unit 142 receives completion operation indicating the input operation on the input screen is completed. Furthermore, when the input receiving unit 142 receives the completion operation, the asynchronous communication unit 151 transmits the pieces of the input information to the web server 200 through the asynchronous communication.

Therefore, the terminal device 100 according to the embodiments can collectively transmit the pieces of the input information to the web server 200 after the user completes the input operation. Therefore, the traffic of the network N can be reduced.

Furthermore, the web server 200 according to the embodiments includes the request receiving unit 231 and the distributing unit 232. The request receiving unit 231 receives, from the terminal device 100, an acquisition request to acquire an input screen containing an input field in which arbitrary information is to be input. When the request receiving unit 231 receives the acquisition request, the distributing unit 232 distributes, to the terminal device 100, an input screen in which a display control program is embedded. The display control program sets an input field to the uneditable state when the input information in the input field does not satisfy the input requirement of the input field.

Therefore, the web server 200 according to the embodiments can use a single web page both as the input screen and the confirmation screen, so that development costs of the web pages can be reduced.

Moreover, the web server 200 according to the embodiments includes the asynchronous communication unit 233. The asynchronous communication unit 233 receives the pieces of the input information from the terminal device 100 through the asynchronous communication, and transmits verification results indicating whether the pieces of the input information satisfy the input requirements to the terminal device 100 through the asynchronous communication.

Therefore, the web server 200 according to the embodiments can perform the verification process with high reliability.

While the embodiments of the present invention have been explained in detail above with reference to the drawings, they are described by way of example only. The present invention may be embodied in various other forms or modified forms based on the knowledge of one skilled in the art, in addition to the embodiments as described above.

Furthermore, the web server 200 as described above may be implemented by multiple server computers. Furthermore, the structure may be changed flexibly depending on functions. The functions may be implemented by calling an external platform or the like by an application programming interface (API) or network computing.

Moreover, “a unit” recited in the claims may be replaced with “a section, a module, or a means” or “a circuit”. For example, the input receiving unit may be replaced with an input receiving means or an input replacing circuit.

According to an embodiment, it is possible to reduce development costs of the web page.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
an input receiving unit configured to receive input operation for inputting arbitrary information in an input field contained in an input screen; and
a screen control unit configured to display the input screen, as a confirmation screen, in which the input field is set to an uneditable state, when the information input in the input field through the input operation satisfies an input requirement of the input field.

2. The terminal device according to claim 1, wherein
the screen control unit includes:
an asynchronous communication unit configured to transmit the input information to a server device that provides the input screen through asynchronous communication, and configured to receive a verification result indicating whether the input information satisfies the input requirement from the server device through the asynchronous communication; and
an edit control unit configured to set the input field to the uneditable state, when the verification result received by the asynchronous communication unit indicates that the input requirement is satisfied.

3. The terminal device according to claim 2, wherein
the screen control unit further includes a verification result display unit configured to display the verification result on the input screen, when the verification result received by the asynchronous communication unit indicates that the input requirement is not satisfied.

4. The terminal device according to claim 2, wherein
the input receiving unit receives operation for returning a screen state of the input screen in which the input field is set to the uneditable state, and
the edit control unit sets the input field to an editable state when the input receiving unit receives the operation.

5. The terminal device according to claim 2, wherein
the input receiving unit receives input operation on multiple input fields contained in the input screen,
the asynchronous communication unit transmits input information to the server device and receives a verification result of the input information from the server device every time information is input in any of the input fields, and
the edit control unit controls editability of each of the input fields contained in the input screen based on the verification result received by the asynchronous communication unit.

6. The terminal device according to claim 2, wherein the edit control unit displays the input field in the uneditable state such that the uneditable state can be discriminated.

7. The terminal device according to claim 2, wherein
the input receiving unit receives completion operation indicating that the input operation on the input screen is completed, and
the asynchronous communication unit transmits the input information to the server device through the asynchronous communication when the input receiving unit receives the completion operation.

8. A display method implemented by a terminal device, the display method comprising:
receiving input operation for inputting arbitrary information in an input field contained in an input screen; and
displaying the input screen, as a confirmation screen, in which the input field is set to an uneditable state, when the information input in the input field through the input operation satisfies an input requirement of the input field.

9. A non-transitory computer-readable storage medium having stored therein an executable display control program causing a computer to execute a process, the process comprising:
displaying, on a predetermined display device, an input screen containing an input field in which arbitrary information is to be input;
transmitting information input in the input field to a server device that provides the input screen through asynchronous communication;
receiving a verification result indicating whether the input information satisfies the input requirement from the server device through the asynchronous communication; and
setting the input field in the input screen displayed on the display device to an uneditable state when the verification result indicates that the input requirement is satisfied.

10. A server device comprising:
a receiving unit configured to receive, from a terminal device, an acquisition request to acquire an input screen containing an input field in which arbitrary information is to be input; and
a distributing unit configured to distribute, to the terminal device, the input screen in which a display control program is embedded when the receiving unit receives the acquisition request, the display control program setting the input field to an uneditable state when the input information in the input field does not satisfy an input requirement of the input field.

11. The server device according to claim 10, further comprising:
an asynchronous communication unit configured to receive the information input in the input field from the terminal device through the asynchronous communication and configured to transmit a verification result indicating whether the input information satisfy the input requirement to the terminal device through the asynchronous communication.
